(19) United States
(12) Patent Application Publication
(10) Pub. No.: US 2002/0027408 A1
(43) Pub. Date: Mar. 7, 2002

(54) Structure of panel in flat-type CRT

(76) Inventors: Byoung-Chul Kim, Seoul (KR); Do-Hoon Kim, Seoul (KR)

Correspondence Address: BIRCH STEWART KOLASCH & BIRCH, PO BOX 747, FALLS CHURCH, VA, 22040-0747, US

(21) Appl. No.: 09/949,716

(22) Filed: Sep. 12, 2001

(30) Foreign Application Priority Data
Sep. 1, 2000 (KR) P2000-51664

(51) Int. Cl. H01J 29/80

(52) U.S. Cl. 313/407

(57) ABSTRACT

Disclosed is a structure of panel in flat-type CRT (Cathode Ray Tube), which is capable of securing a stable vacuum intensity by applying a sufficient tension to a face part of a panel using a straight safety band, and of effectively reducing an advance of crack and a scatter of fragments due to an external shock by optimizing the relationship among an MMH (Mold Match Height), a CFT (Center Face Thickness) and an OAH (Overall Height), which are design factors. The structure of panel in flat-type CRT (Cathode Ray Tube) includes a face part having a flat outer surface and an inner surface of a fixed curvature, and a skirt part extending from an edge of the face part to a rear portion. When a height from a MML (Mold Match Line), which is an extension line of a match line between an upper external mold and a lower external mold to form the panel, to an outer center of a face of the panel is designated as a MMH and a thickness of the center of the face surface of the panel is designated as a CFT, the relationship between the MMH and the CFT satisfies MMH≦CFT.

### BACKGROUND OF THE INVENTION

1. Field of the Invention

The present invention relates to a structure of panel in flat-type CRT (Cathode Ray Tube), and more particularly, to a structure of panel in flat-type CRT, which is capable of improving proof-explosion properties of a flat-type CRT by effectively reducing an advance of crack by an external shock and a scatter of fragments.

2. Description of the Related Art

In general, as shown in FIG. 1, a flat-type CRT (Cathode Ray Tube) includes: a panel 1; a shadow mask 3 fixed on a rear surface of the panel 1 in a state that a tension is applied to the shadow mask 3 and having a plurality of apertures of round or slot type for serving to select colors of an electron beam 6; a magnetic shield 7 fixed on the inside of the panel 1 and serving to screen the electron beam 6 from being changed in course by an earth magnetic field or a leakage magnetic field; a funnel 2 fixed on the panel 1 by a frit glass and having a neck part formed integrally at a rear portion; an electric gun (not shown) inserted and sealed in the neck part of the funnel 2 for emitting the electron beam 6 of three colors, i.e., R, G and B colors; and a deflection yoke 5 mounted to wrap the external circumference of the neck part for deflecting the electron beam 6.

Meanwhile, because the inside of the flat-type CRT may be easily damaged due to the external shock as being in a high vacuum condition, the panel 1 is designed to have an intensity to endure atmospheric pressure.

Moreover, the panel 1 is divided into a face part 1a and a skirt pail 1b. The skirt part 1b has a safety band 8 mounted to disperse a stress applied to the flat-type CRT of the high vacuum condition and to secure shock resistance capacity.

When the flat-type CRT is operated, the electron beam 6 of the electric gun mounted in the neck part of the funnel 2 strikes a luminescence surface 4 formed on an inner surface of the panel by anode voltage applied to the flat-type CRT. The electron beam 6 is deflected in all directions by the deflection yoke 5 before reaching the luminescence surface 4, and then reaches the luminescence surface 4.

At this time, the neck part has magnets 9 of bipolarity, tetrapolarity and hexapolarity at a rear portion for correcting an advance orbit in order for the electron beam 6 to strike a prescribed fluorescence body, thereby preventing badness of color purity.

Referring to FIG. 2a, a structure of the panel of the flat-type CRT will be described hereinafter in more detail.

In general, the panel of the flat-type CRT has an outer surface being is in the form of a plane and a curved inner surface having a prescribed curvature. As shown in FIG. 2a, the panel 1 is the thinnest in a center face thickness (hereinafter, called as a CFT) and becomes gradually thicker toward the outer circumference.

The outer circumference of the panel 1 has a discontinuous part generated during a molding process of the panel. The discontinuous part is a mold match line (hereinafter, called as a MML) and is the same form that a belt is bound round the outer circumference of the panel.

At this time, a size of a mold match height (hereinafter, called as a MMH), which is a height from the MML to a front surface of the panel 1, is larger than that of the CFT of the panel 1.

Especially, an opposite angle portion thickness (OAPT) of the panel 1 is designed to be thick 160% or more, compared with the CFT.

A height from an end of the skirt part 1b of the panel 1 to a front surface of the face part 1a is designated as an overall height (hereinafter, called as an OAH)

A manufacturing process of the panel of the conventional flat-type CRT will be described as follows.

In general, as shown in FIG. 2a, the outer circumference of the panel 1 has prescribed angles θ1 and θ2 formed toward the face part 1a and the skirt part 1b respectively centering around the MML. Thus, in consideration of a slip of the mold, if only one external mold is used, the molding cannot be performed.

Therefore, as shown in FIG. 2b, one internal mold 10 and two external molds 11a and 11b are combined and used.

Here, the external molds are divided into an upper external mold 11a and a lower external mold 11b.

Therefore, when the panel 1 is molded, the upper and lower external molds 11a and 11b are matched to form an external form of the panel 1. After a glass material of a prescribed amount is inserted into the external molds 11a and 11b, the internal mold 10 to form the inner surface of the panel 1 is lowered to a position where a prescribed interval between the internal mold 10 and the external molds 11a and 11b is kept. After that, the internal mold 10 is raised up after a predetermined period of time is passed.

At this time, the panel 1 must be formed to have a thickness sufficient to endure a predetermined vacuum pressure after the CRT is finished. The interval between the external molds 11a and 11b and the internal mold 10 must be set to have different intervals according to the standard of the panel 1.

That is, the CFT of the panel 1 is determined by the interval between the center of the external molds 11a and 11b and the center of the internal mold 10.

Because the cathode ray tube manufactured by the above is made of the glass material and the inside of the cathode ray tube is in a vacuum condition, there is a danger of accidents by a scatter of the fragments if crack or explosion occurs by the external shock. The safety band 8 of a metal material is attached to the skirt part 1b of the panel 1 to prevent the danger.

The reason that the safety band 8 is attached to the skirt part 1b of the panel 1 is that the most tension stress by the vacuum is caught to the skirt part 1b and the scatter of the glass fragments is generated in the skirt part 1b most well.

Therefore, the safety band 8 is contacted to the skirt part 1b of the panel 1 most effectively to sufficiently apply a tension of the safety band 8.

At this time, the tension of the safety band 8 must sufficiently reach not only the skirt part 1b but also the face part 1a of the panel 1.

Conventionally, the safety band 8, which is bent to correspond with the outer angles of panel 1 of lower portion of MML θ1 and with the outer angles of panel 1 of upper portion of MML θ2, is used to transfer the sufficient tension to the face part 1a of the panel 1.

However, the problem that the tension of the safety band 8 is not applied sufficiently to the face part 1a in spite of the bent structure of the safety band 8 is still remained.

That is, as shown in the drawing, based on the MML, because a circumference of the skirt part 1b located at the lower portion of the MML is larger than that of the face part 1a located at the upper portion of the MML, when the safety band 8 wound in a heat expansion state is contracted while cooled, stronger tension is applied to the skirt part 1b, which has the outer circumference larger than that of the face part 1a, compared to the face part 1a.

In the conventional panel 1, as described above, because the tension is not sufficiently applied to the face part 1a of the panel 1, the crack generated by the shock easily advances to the inside of the panel 1 as shown in FIG. 4, and thereby the crack may be generated throughout the face part 1a of the panel 1.

That is, in the structure of the conventional panel 1, the MML located at the lower portion of the CFT does not effectively prevent the advance of the crack toward the inside of the panel, and thereby there is a limitation in that the panel 1 has a stable proof-explosion properties.

Furthermore, to use the safety band 8 of the bent structure, equipments for bending a straight band must be prepared, and thus additional fees for preparing the equipment are required. Moreover, a recovery rate of the product is lowered in comparison with the straight band 8, and thus manufacturing costs are increased.

The reason that the safety band 8 of the bent structure is used in spite of the above disadvantages is to solve a problem of the straight safety band that the safety band is contacted to only the skirt part 1b located at the lower portion of the MML of the panel 1 and thereby the tension is concentrated on the skirt part 1b.

That is, in case of using the straight safety band on the panel 1, because the angle θ2 formed toward the face part 1a located at the upper portion based on the MML is still larger than the angle θ1 formed toward the skirt part 1b located at the lower portion based on the MML, the tension of the safety band is concentrated on the skirt part 1b, and thereby the crack of the face part 1a advancing by the external shock is not reduced effectively and the scatter of the fragments by the shock is not prevented effectively.

Meanwhile, it is advantageous to reduce the MMH to apply stronger tension to the face part 1a of the panel 1 and to secure the stable proof-explosion properties.

However, if the OAH is remained at it is and only the MMH is reduced, the length of the skirt part 1b becomes long. Thus, in case forming the panel using the mold, when the upper external mold 11a is separated, scratch or transformation may occur in the skirt part 1b.

Furthermore, in case that the OAH is remained at it is and only the MMH is reduced, if the upper external mold 11a is separated in a state that the glass material is not sufficiently cooled, the skirt part 1b, which is not hardened completely after the molding, may be transformed due to a self-weight. Moreover, even though the transformation due to the self-weight does not occur, the skirt part 1b may be transformed by being shaken by external influences, e.g., vibration of a conveyer, when the skirt part 1b is transferred to the next step.

Meanwhile, the CRT, which has the inside of the vacuum condition, must effectively recover a depression of the panel 1 due to the vacuum condition by the reinforcement of the safety band. However, if the length of the skirt part 1b of the panel 1 is short, the safety band cannot secure a sufficient width, and thereby the CRT cannot recover the panel 1 to its original condition.

Moreover, if the length of the skirt part 1b of the panel 1 is short, the tension stress against glass products is applied to a conjunction part between the panel 1 and the funnel 1. To solve the above problem, the OAH must be long.

On the contrary, if the length of the skirt part 1b of the panel 1 is too long, the skirt part 1b of the panel 1 becomes thin to secure available picture area in the inside of the panel 1. In this case, a relatively high stress is applied to a connection part between the face part 1a and the skirt part 1b.

In brief, in the conventional panel structure, since the MMH is larger than the CFT, the sufficient tension is not applied to the face part 1a, and thus it is difficult to obtain a stable vacuum intensity and to effectively reduce the advance of the crack. Furthermore, equipment fees for bending the safety band are required.

Therefore, to solve the above problems and to secure the stable vacuum intensity and the proof-explosion properties of the panel 1, a demand of the optimization of the relationship among the MMH, the CFT and the OAH is on the rise.

### SUMMARY OF THE INVENTION

It is, therefore, an object of the present invention to provide a panel in flat-type CRT (Cathode Ray Tube), which is capable of securing a stable vacuum intensity by applying a sufficient tension to a face part of a panel even though a straight safety band is used.

It is another object of the present invention to provide a panel in flat-type CRT, which is capable of effectively reducing an advance of crack and a scatter of fragments due to the external shock.

It is a further object of the present invention to provide a panel in flat-type CRT, which optimizes the relationship among an MMH (Mold Match Height), a CFT (Center Face Thickness) and an OAH (Overall Height), which are design factors, to make a distribution of stress of an outer surface of the CRT even and to prevent concentration of a tension stress.

To achieve the above objects, the present invention provides a structure of panel in flat-type CRT (Cathode Ray Tube), which includes a face part having a flat outer surface and an inner surface of a fixed curvature, and a skirt part extending from an edge of the face part to a rear portion, wherein, when a height from a MML (Mold Match Line) to an outer center of a face of the panel is designated as a MMH and a thickness of the center of the face surface of the panel is designated as a CFT, the relationship between the MMH and the CFT satisfies MMH≦CFT, the MML being an extension line of a match line between an upper external mold and a lower external mold to form the panel.

When a height from an end of the skirt part of the panel to a front surface of the face part is designated as an OAH, the relationship between the OAH and the CFT satisfies 0.12≦CFT/OAH≦0.15.

### BRIEF DESCRIPTION OF THE DRAWINGS

Further objects and advantages of the invention can be more Fully understood from the following detailed description taken in conjunction with the accompanying drawings in which:

FIG. 1 is a side sectional view, partly in section, of a structure of a conventional flat-type CRT (Cathode Ray Tube);

FIG. 2a is a cross sectional view for explaining the structure of FIG. 1;

FIG. 2b is a schematic view of a structure of a mold for forming the panel of FIG. 1;

FIG. 3 is a cross sectional view of a structure of a panel according to the present invention;

FIG. 4 is a cross sectional view showing a difference in an advance of crack between the conventional panel and the present invention;

FIG. 5 is a graph showing an analysis result of vacuum intensity according to the change of a CFT (Center Face Thickness) of the panel according to the present invention;

FIGS. 6a and 6b are graphs showing analysis results of proof-explosion properties according to the change of a MMH (Mold Match Height) of the panel according to the present invention, wherein

FIG. 6a is a graph of the relationship between the MMH and a length of the crack; and

FIG. 6b is a graph of the relationship between the MMH and a distance of fragment scatter; and

FIG. 7 is a graph showing an analysis result of stress according to the change of the CFT/OAH (Overall height) of the panel according to the present invention

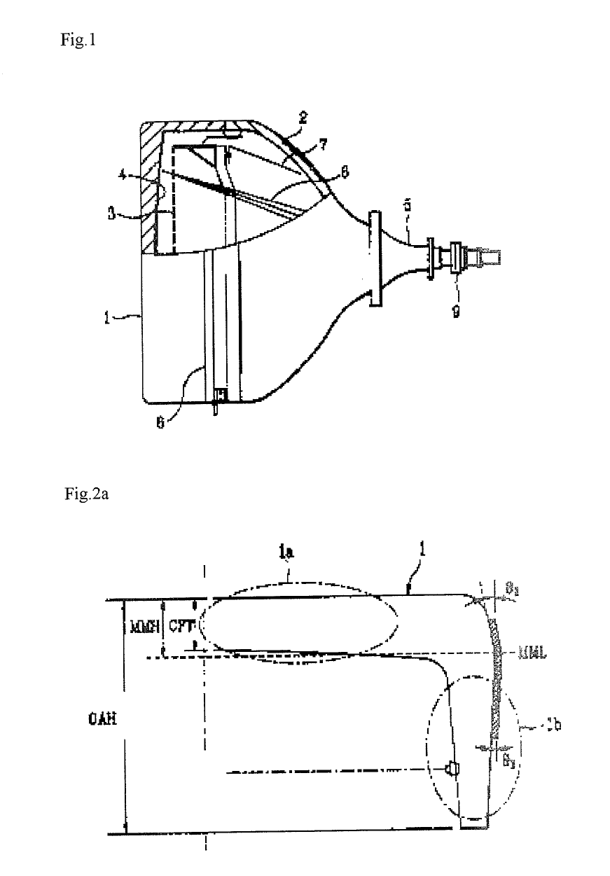

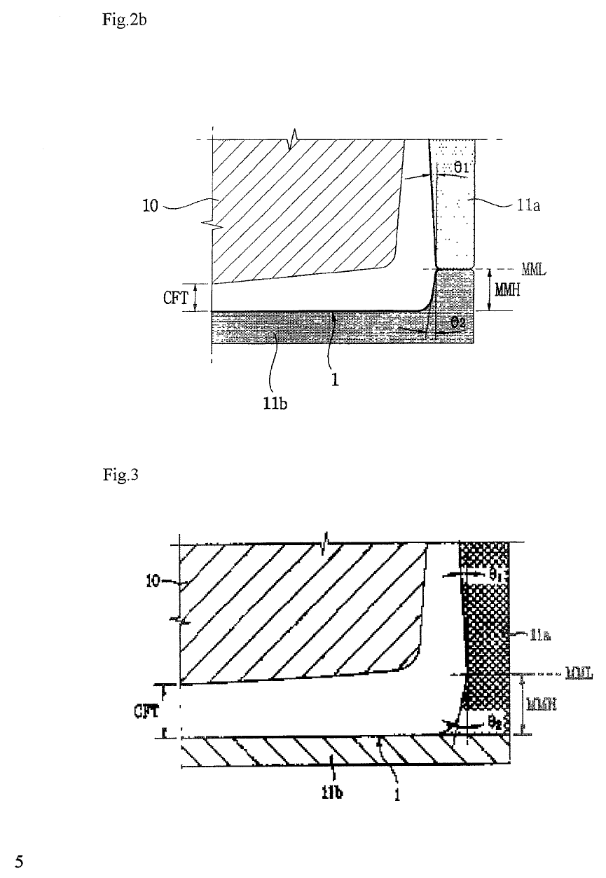

### DETAILED DESCRIPTION OF THE PREFERRED EMBODIMENT

The present invention will now be described in detail in connection with preferred embodiments with reference to the accompanying drawings. For reference, like reference characters designate corresponding parts throughout several views.

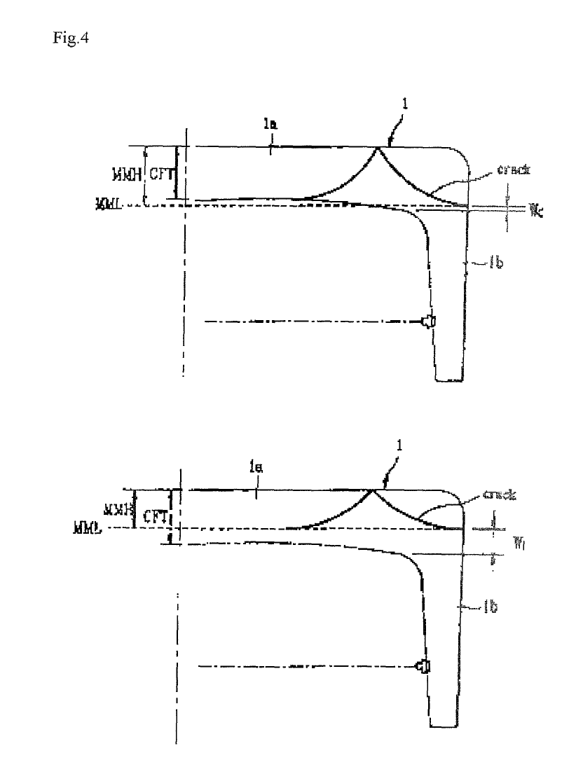

Referring to FIGS. 3 through 7, a preferred embodiment of the present invention will be described in detail as follows.

A conventional panel for a CRT (Cathode Ray Tube) having a curvature in inner and outer surfaces is advantageous in a vacuum intensity, but a panel 1 for flat-type CRT having a flat outer surface and an inner surface, which becomes gradually even, to flatten visually is disadvantageous in the vacuum intensity and to secure a stable vacuum intensity.

That is, the proof-explosion properties of the flat-type CRT improve by optimizing the relationship among an MMH (Mold Match Height), a CFT (Center Face Thickness) and an OAH (Overall Height), which are design factors.

Therefore, it is required to optimize the relationship between design factors of the panel 1 to secure a stable vacuum intensity of the panel 1 for the flat-type CRT and to improve proof-explosion properties,

For this, in this invention, the relationship among an MMH (Mold Match Height), a CFT (Center Face Thickness) and an OAH (Overall Height) in the panel for the flat-type CRT is optimized by analyzing the relationship between the CFT and the vacuum intensity, the relationship between the MMH and a length of crack, the relationship between the MMH and a scatter distance of fragments, and the relationship between the CFT/OAH and a stress. Referring to FIGS. 3 through 7, an application of the present invention to a panel of the flat-type CRT of more than 29 inch will be described in detail hereinafter.

First, referring to FIGS. 3 and 5, the relationship between the CFT and the vacuum intensity in the panel according to the present invention will be described.

FIG. 3 is a cross sectional view of a structure of the panel according to the present invention and FIG. 5 is a graph of an analysis result of the vacuum intensity according to the change of the CFT of the panel 1 according to the present invention In the case of the panel 1 applied to the flat-type CRT of more than 29 inch in standard, as shown in FIGS. 3 and 5, if the relationship between the MMH and the CFT satisfies MMH≦CFT and the CFT is more than 15 mm so that the stress applied to the CRT is lower than 100 kgf, the stable vacuum intensity can be secured, wherein the MMH means a height from a MML (Mold Match Line), which is an extension line of a match line between an tipper external mold 11b and a lower external mold 1lb to form the panel 1, to an outer center of a face of the panel 1, and the CFT means a thickness of the center of the face surface of the panel 1.

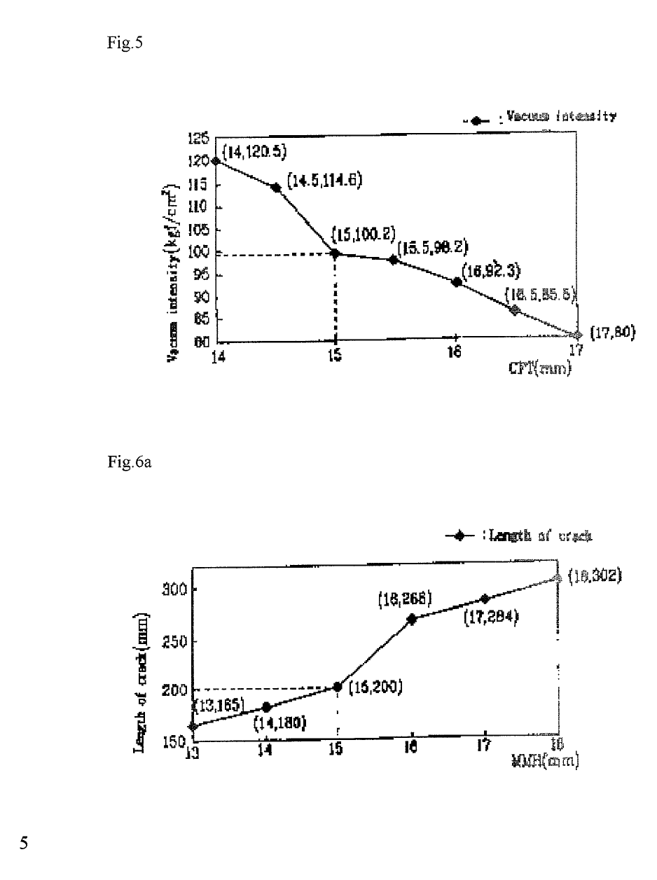

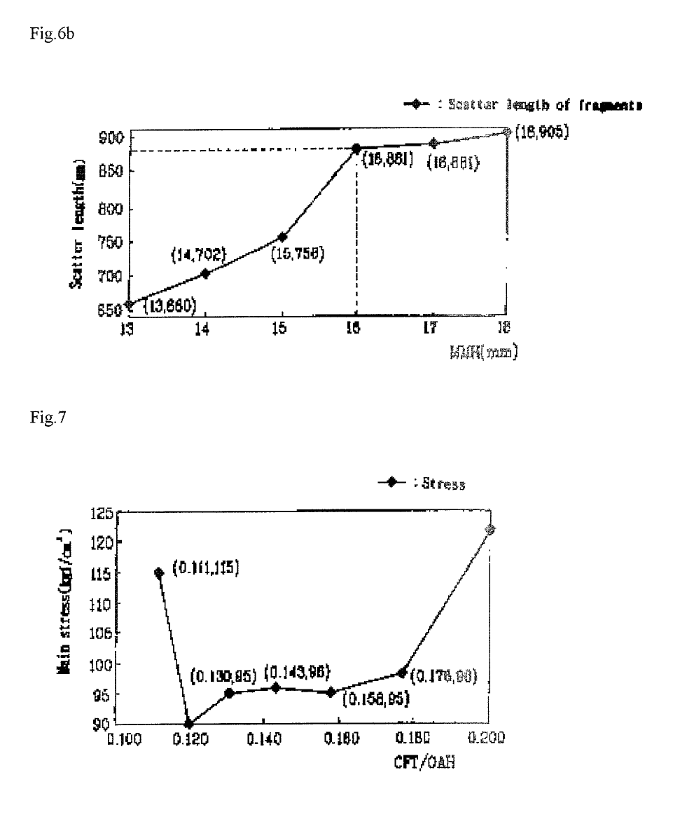

Next, referring to FIGS. 6a and 6b, the relationship between the change of the MMH to the CFT of the panel and the proof-explosion properties will be described.

FIGS. 6a and 6b are graphs showing analysis results of the proof-explosion properties according to the change of a MMH of the panel according to the present invention, wherein FIG. 6a is a graph of the relationship between the MMH and the length of the crack and FIG. 6b is a graph of the relationship between the MMH and the scatter distance of the fragments.

In the structure of the panel according to the present invention by changing the MMH in a state that the CFT is set to 15 mm, the proof-explosion properties are obtained as shown in FIGS. 6a and 6b.

That is, in case of the CFT of 15 mm in the panel of the flat-type CRT of more than 29 inch in standard, if the MMH is larger than 15 mm, an advance distance of the crack is rapidly increased, and thus the relationship of MMH≦CFT must be satisfied to effectively reduce the advance of the crack.

In other words, as shown in FIG. 6a, in case that the CFT is 15 mm in length and only the MMH is changed, if the MMH is shorter than 15 mm, the change in the scatter distance of crack and the length of the crack are smooth, but if the MMH is larger than the CFT, the scatter distance and the length of the crack are rapidly changed.

Here, the scatter distance of fragments means a distance of fragments of the panel 1 sputtered from a face part 1a when the panel 1 is broken by the shock. Based on one fragment, which is 0.025 g in weight, if the scatter distance of the fragment is more than 900 mm, it cannot satisfy standard conditions of the standard certifying organization.

From the analysis of the relationship between the CFT and the vacuum intensity and the analysis of the proof-explosion properties of the relationship between the CFT and the MMH, it is known that a contact area with the face part 1a becomes wider if the MMH is smaller than the CFT, and thereby the tension of a safety band reaches the face part 1a sufficiently and the advance of the crack due to the external shock is effectively prevented.

Namely, a width of the face part 1a of the panel 1 located at a lower portion of the MML is expanded to the extent of a difference between the CFT and the MMH of FIG. 3 and the contact area is expanded if a circumference of the outer surface of the panel is multiplied to the expanded width.

Therefore, as described above, by making the MMH shorter than the CFT, even though a straight safety band 8a shown in FIG. 3 is used without using a bent explosion band 8, the flat-type CRT of sufficient proof-explosion properties can be manufactured.

Especially, because the present invention has an excellent contact efficiency between the safety band 8a and the face part 1a of the panel, in case that the safety band is made of a material having the same intensity as the conventional safety band, although the safety band, which is thinner than the conventional safety band, is used, the stable proof-explosion properties can be secured.

Hereinafter, referring to FIG. 7, an analysis result of stress according to the change of CFT/OAH value of the panel according to the present invention will be described.

FIG. 7 is a graph of the analysis result of stress according to the change of CFT/OAH value of the panel 1 of the present invention. If the OAH is changed in a state that the CFT of the panel 1 for the flat-type CRT is fixed, a size of main stress and a generation position of the stress are changed.

That is, as shown in FIG. 7, in case that the CFT is 15 mm, the OAH is 135 mm and the CFT/OAH is 0.11, the main stress of 115 kgf is generated at the lower portion of the MML. In case that the CFT is 15 mm, the OAH is 75 mm and the CFT/OAH is 0.200, the main stress of 122 kgf is generated at the conjunction part between the panel 1 and the funnel 2.

Therefore, in case of the CFT of 15 mm, if the CFT/OAH value is within to a range of 0.12 through 0.15, the main stress is small and its generation position is the face part 1a, thereby securing the stable vacuum intensity.

In FIG. 7, when the CFT/OAH value is 0.158, the main stress is 95 kgf, which is smaller than the CFT/OAH of 0.15. When the CFT/OAH value is 0.15, the main stress is applied to the panel, but when the CFT/OAH value is 0.158, the main stress is applied to the conjunction part of the panel and the funnel. The conjunction part is a relatively weak part in the vacuum condition of the CRT. If the main stress is applied to the conjunction part, the conjunction part may be damaged by the concentration of the stress Thus, it is preferable that the CFT/OAH value is within the range of 0.12 to 0. 15.

FIG. 7 shows an analysis result in a state that the CFT is set to 15 mm. However, if the CFT/OAH is within the range of 0.12 to 0.15 even though the CFT is larger than 15 mm, the stress is small and the stress is applied to the face part 1a, thereby securing the stable vacuum intensity.

Namely, because a length of a skirt part 1b becomes long if the OAH is too large under the fixed CFT, the main stress is concentrated on the lower portion of the MML If the OAH is too short, the main stress is concentrated on the conjunction part between the panel 1 and the funnel 2, and thus it is disadvantageous in obtaining the stable vacuum intensity.

Furthermore, if the OAH is calculated when the relationship between the OAH and the CFT is 0.12≦CFT/OAH≦0.15, 100 mm≦OAH≦125 mm is obtained in case of the CFT of 15 mm, and 90 mm≦OAH≦133 mm is obtained in case of the CFT of 14 to 16 mm.

As described above, in the present invention, even though the straight safety band 8a is used in the present invention, the contact area between the safety band 8a and the face part 1a of the panel is expanded, and the relationship between among the MMH, the CFT and the OAH, which are design factors of the panel 1, is optimized to apply the sufficient tension to the face part 1a of the panel 1, so that the panel 1 for the flat-type CRT can have the stable vacuum intensity and the proof-explosion properties.

Therefore, the improvement of the vacuum intensity and of the proof-explosion properties of the panel by the optimization of the relationship among the MMH, the CFT and the OAH is effective in improving a reliability of the flat-type CRT.

That is, because the sufficient tension can be applied to the lace part of the panel even though the straight safety band, which is easy in manufacturing, is used, there is not a burden of additional fees required for bending the safety band and the stable vacuum intensity can be secured. Furthermore, the advance of the crack due to the external shock can be restricted and the scatter of the fragments can be reduced effectively, so that the proof-explosion properties are considerably improved. Therefore, the present invention has various effects in aspects of productivity and reliability of the products.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A structure of panel in flat-type CRT (Cathode Ray Tube), which includes a face part having a flat outer surface and an inner surface of a fixed curvature, and a skirt part extending from an edge of the face part to a rear portion,
wherein, when a height from a MML (Mold Match Line) which is an extension line of a match line between an upper external mold and a lower external mold to form the panel to an outer center of a face of the panel is designated as a MMH and a thickness of the center of the face surface of the panel is designated as a CFT, the relationship between the MMH and the CFT satisfies MMH≦CFT.

2. The structure as claimed in claim 1, wherein, when a height from an end of the skirt part of the panel to a front surface of the face part is designated as an OAH, the relationship between the OAH and the CFT satisfies 0.12≦CFT/OAH≦0.15.

3. A structure of panel in flat-type CRT (Cathode Ray Tube), which includes a face part having a flat outer surface and an inner surface of a fixed curvature, and a skirt part extending from an edge of the face part to a rear portion,
wherein, when a height from a MML (Mold Match Line) which is an extension line of a match line between an upper external mold and a lower external mold to form the panel to an outer center of a face of the panel is designated as a MMH and a thickness of the center of the face surface of the panel is designated as a CFT, the relationship between the MMH and the CFT satisfies MMH≦CFT and the CFT is larger than 15 mm.

4. The structure as claimed in claim 3, wherein, when a height from an end of the skirt part of the panel to a front surface of the face part is designated as an OAH, the relationship between the OAH and the CFT satisfies 0.12≦CFT/OAH≦0.15.

5. The structure as claimed in claims 1 and 4, wherein the OAH satisfies 90≦OAH≦133.
